(19) United States
(12) Patent Application Publication
(10) Pub. No.: US 2012/0306872 A1
(43) Pub. Date: Dec. 6, 2012

(54) Stereoscopic Display Device and Stereoscopic Display Method

(75) Inventors: Yoshiaki Owaki, Osaka (JP); Mitsuhiro Mori, Osaka (JP)

(73) Assignee: PANASONIC CORPORATION, Kadoma-shi, Osaka (JP)

(21) Appl. No.: 13/577,908

(22) PCT Filed: Jan. 13, 2011
(86) PCT No.: PCT/JP2011/000149

§ 371 Date: Aug. 9, 2012

(30) Foreign Application Priority Data
Feb. 9, 2010 (JP) 2010-026174

(51) Int. Cl. G06T 15/00

(52) U.S. Cl. 345/419

(57) ABSTRACT

A stereoscopic display device for displaying left-eye and right-eye images in alternation on a display to show the images as a stereoscopic image. The stereoscopic display device includes: an average picture-signal level calculation section configured to calculate an average picture-signal levels of the left-eye images and the right-eye images, respectively; a drive parameter calculation section configured to calculate drive parameters, corresponding to the respective average picture-signal levels calculated by the average picture signal-level calculation section, for showing the image stereoscopically; a selection section configured to select one of either the drive parameter corresponding to the average picture-signal level of the left-eye image or the drive parameter corresponding to the average picture-signal level of the right-eye image, calculated by the drive parameter calculation section; and a control section configured to display the left-eye and right-eye images on the display, based on the drive parameter selected by the selection section.

### TECHNICAL FIELD

The present invention relates to stereoscopic display devices for displaying stereoscopic images, and more particularly to stereoscopic display devices for adjusting the brightness at which the left-eye images and the right-eye images are displayed, to improve the viewability of the stereoscopic images.

### BACKGROUND ART

As one area of recent image-display technology, stereoscopic display systems are becoming widespread. By means of a stereoscopic display device that displays left-eye images and right-eye images in alternation, and a shutter eyewear in which a left-eye shutter and a right-eye shutter are opened and closed in synchronization with the display of the left-eye images and the right-eye images, stereoscopic display systems enable the viewing of stereoscopic images.

In such stereoscopic display systems, the quality of the displayed stereoscopic images, in particular, the viewability, is influenced directly by how well display of the left eye image and the right eye image is controlled.

Patent Literature 1 discloses a technique for correcting image quality based on average brightness levels of the left-eye and right-eye images. According to this reference, the average brightness level and dynamic range (the difference between maximum brightness and minimum brightness) of the picture signal for one of either the left-eye image or the right-eye image is matched to the average brightness level and dynamic range of the picture signal for the other.

Further, as a typical method for improving viewability for a plasma display panel (hereinafter, abbreviated as a “PDP”), for example, a method for adjusting the number of subfields (hereinafter, abbreviated as “SFs”), and a method for controlling brightness by changing the number of times electric discharge is performed, are disclosed (see, for example, Patent Literature 2 and Patent Literature 3).

FIG. 13 is a block diagram illustrating a configuration of a brightness control section 900 according to conventional art for controlling the brightness level of an image. In FIG. 13, the brightness control section 900 includes an inverse gamma corrector 910, a one frame delay unit 920, an average level calculator 930, a vertical synchronization frequency detector 940, an image characteristic determination unit 950, a picture-signal—subfield correlation unit 960, a pulse-count-per-unit-subfield setter 970, and a subfield processor 980.

The inverse gamma corrector 910 subjects, to an inverse gamma correction, R(RED), G(GREEN), and B(BLUE) input picture signals having been obtained by analog-to-digital (A/D) conversion.

The one frame delay unit 920 generates a picture signal by delaying, by one frame period, a picture signal outputted from the inverse gamma corrector 910, and outputs the generated picture signal to the picture-signal—subfield correlation unit 960.

The average level calculator 930 calculates an average picture signal level (APL: Average Picture Level) based on the picture signal outputted by the inverse gamma corrector 910, and outputs the APL to the image characteristic determination unit 950.

The vertical synchronization frequency detector 940 detects a vertical synchronization frequency based on a vertical synchronizing signal from an input terminal VD and a horizontal synchronizing signal from an input terminal HD. The vertical synchronization frequency of a television signal is 60 Hz (standard frequency) in general, and the vertical synchronization frequency of a picture signal of a personal computer is a frequency (for example, 72 Hz) higher than the standard frequency. Therefore, in order to output a picture signal from a personal computer to a PDP, the vertical synchronization frequency needs to be adjusted. Therefore, when the vertical synchronization frequency detector 940 detects a vertical synchronization frequency higher than the standard frequency, the vertical synchronization frequency detector 940 outputs a signal representing the vertical synchronization frequency to the image characteristic determination unit 950.

The image characteristic determination unit 950 calculates the number of SFs and a constant multiplying coefficient (hereinafter, abbreviated as a “multiple”), based on the APL outputted from the average level calculator 930.

The picture-signal—subfield correlation unit 960 generates a subfield picture signal, based on the picture signal which has been outputted from the one frame delay unit 920 so as to be delayed by one frame period, and on the number of SFs outputted from the image characteristic determination unit 950, and outputs the subfield picture signal to the subfield processor 980.

The pulse-count-per-unit-subfield setter 970 sets the number of sustain pulses necessary for each subfield, based on the multiple outputted from the image characteristic determination unit 950, and outputs the number of sustain pulses to the subfield processor 980.

The subfield processor 980 generates a PDP drive signal based on the subfield picture signal outputted from the picture-signal—subfield correlation unit 960, and generates a pulse signal based on the number of the sustain pulses outputted from the pulse-count-per-unit-subfield setter 970.

A display section 1000 includes a data-driven circuit 1010, a scanning/sustaining/elimination drive circuit 1020, and a plasma display panel 1030. The PDP drive signal outputted from the subfield processor 980 is inputted to the data-driven circuit 1010, and the pulse signal outputted from the subfield processor 980 is inputted to the scanning/sustaining/elimination drive circuit 1020, to display a stereoscopic image having its brightness controlled, on the plasma display panel 1030.

As described above, in the stereoscopic display device according to the conventional art, the brightness control section 900, which controls a brightness level of an image, controls brightness of a left eye image and a right eye image by using the APL, the number of SFs, and the like.

### CITATION LIST

### Patent Literature

Patent Literature 1: Japanese Laid-Open Patent Publication No. 2-58993

Patent Literature 2: Japanese Patent No. 2994630

Patent Literature 3: Japanese Laid-Open Patent Publication No. 2001-125536

### SUMMARY OF THE INVENTION

### Problems to be Solved by the Invention

However, a view angle is different between a left eye and a right eye, and the left eye image and the right eye image used for the stereoscopic display may represent different images for marginal portions although the left eye image and the right eye image represent the same image in the center portion, or regions hidden behind an object located in front of the regions may be different therebetween. FIG. 14 illustrates a left eye image and a right eye image displayed by the stereoscopic display device. As shown in FIG. 14, for example, regions hidden behind a person that exists at the center of an image are different between the left eye image and the right eye image. Therefore, the left eye image and the right eye image are different from each other in brightness, so that a user may feel the stereoscopically displayed image unnatural, and eye fatigue is caused, thereby causing a problem of viewability.

Further, in the stereoscopic television signal processing device described in Patent Literature 1, although the average brightness level of the picture signal of one of either the left eye image or the right eye image is matched to the average brightness level of the picture signal of the other thereof, a minute correction is not performed according to the average brightness level of each of the left eye image and the right eye image, and a variety of contents cannot be efficiently displayed with high viewability. Further, prevention of occurrence of image corruption caused by the correction, and reduction of power consumption which is recently required from society need to be considered.

Therefore, an object of the present invention is to make available a stereoscopic display device and a stereoscopic display method for realizing a high-quality stereoscopic display so as to reduce a variation between a left eye image and a right eye image, and enable excellent viewability, preventing occurrence of image corruption caused by correction, and also enabling reduction of power consumption.

### Solution to the Problems

In order to attain the aforementioned object, the stereoscopic display device of the present invention is directed to a stereoscopic display device for displaying left-eye and right-eye images in alternation on a display to show the images as a stereoscopic image, the stereoscopic display device comprising: an average picture-signal level calculation section configured to calculate an average picture-signal levels of the left-eye images and the right-eye images, respectively; a drive parameter calculation section configured to calculate drive parameters, corresponding to the respective average picture-signal levels calculated by the average picture signal-level calculation section, for showing the image stereoscopically; a selection section configured to select one of either the drive parameter corresponding to the average picture-signal level of the left-eye image or the drive parameter corresponding to the average picture-signal level of the right-eye image, calculated by the drive parameter calculation section; and a control section configured to display the left-eye and right-eye images on the display, based on the drive parameter selected by the selection section.

Preferably, given that the brightness of an image represented by the drive parameter calculated by the drive parameter calculation section diminishes with increase in the average picture-signal level, the selection section selects, from between the drive parameter corresponding to the average picture-signal level of the left-eye image and the drive parameter corresponding to the average picture-signal level of the right-eye image, the drive parameter whereby the brightness decreases.

Alternatively, preferably, given that the brightness of an image represented by the drive parameter calculated by the drive parameter calculation section augments with increase in the average picture-signal level, the selection section selects one of either the drive parameter corresponding to the average picture-signal level of the left-eye image or the drive parameter corresponding to the average picture-signal level of the right-eye image, based on a mode selection signal representing a mode of use for the stereoscopic display device.

Further, preferably, the selection section: selects a drive parameter for increasing the brightness from between the drive parameter corresponding to the average picture-signal level of the left eye image and the drive parameter corresponding to the average picture-signal level of the right eye image when the mode selection signal contains information representing an image enhancement mode for enhancing the images; and selects a drive parameter for reducing the brightness from between the drive parameter corresponding to the average picture-signal level of the left eye image and the drive parameter corresponding to the average picture-signal level of the right eye image when the mode selection signal contains information representing a power-saving mode for reducing power consumption of the stereoscopic display device.

Further, in order to attain the aforementioned object, the stereoscopic display device of the present invention is directed to a stereoscopic display device for displaying left-eye and right-eye images in alternation on a display to show the images as a stereoscopic image, the stereoscopic display device comprising: an average picture-signal level calculation section configured to calculate an average picture-signal levels of the left-eye images and the right-eye images, respectively; an average picture-signal level selection section configured to select one of either the average picture signal level of the left-eye image or the average picture signal level of the right-eye image calculated by the average picture-signal level calculation section; a drive parameter calculation section configured to calculate a drive parameter corresponding to the average picture-signal level selected by the average picture-signal level selection section, for showing the image stereoscopically; and a control section configured to display the left-eye and right-eye images on the display, based on the drive parameter calculated by the drive parameter calculation section.

Preferably, given that the brightness of an image represented by the drive parameter calculated by the drive parameter calculation section diminishes with increase in the average picture-signal level, the average picture-signal level selection section selects the greater of the average picture signal level of the left-eye image and the average picture-signal level of the right-eye image.

Alternatively, preferably, given that the brightness of an image represented by the drive parameter calculated by the drive parameter calculation section augments with increase in the average picture-signal level, the average picture-signal level selection section selects one of either the average picture signal level of the left-eye image or the average picture signal level of the right eye image, based on a mode selection signal representing a mode of use for the stereoscopic display device.

Further, preferably, the average picture signal level selection section: selects the greater of the average picture-signal level of the left-eye image and the average picture-signal level of the right-eye image when the mode selection signal contains information representing an image enhancement mode for enhancing the images; and selects the smaller of the average picture-signal levels of the left-eye image and the average picture-signal level of the right eye image when the mode selection signal contains information representing a power-saving mode for reducing power consumption of the stereoscopic display device.

Further, preferably, the average picture-signal level calculation section calculates an average picture-signal level of a shared image area common to the left-eye image and the right-eye image.

Further, preferably, the average picture-signal level calculation section calculates the average picture-signal level of the left-eye image from a plurality of left-eye images and the average picture-signal level of the right-eye image from a plurality of right-eye images, among a plurality of temporally continuous left-eye images and right-eye images.

Further, preferably, the display is a plasma display panel; and the control section controls brightness of the plasma display panel by adjusting light emission of subfields of the left-eye image and the right-eye image.

In addition, in order to attain the aforementioned object, process steps executed by the components of the stereoscopic display device of the present invention as described above can be implemented as a stereoscopic display method including a series of process steps. This method is implemented in a form of a program for causing a computer to execute the series of process steps. The program may be stored in a computer-readable storage medium and introduced into the computer.

### Advantageous Effects of the Invention

As described above, in the stereoscopic display device and the stereoscopic display method according to the present invention, a high-quality stereoscopic display can be realized so as to reduce a variation between a left eye image and a right eye image, and enable an excellent viewability, and while occurrence of image corruption caused by a high brightness can be prevented, reduction of power consumption or enhancement of a stereoscopic image for display can be realized.

### BRIEF DESCRIPTION OF THE DRAWINGS

FIG. 1 is a perspective view of outlines of a stereoscopic display device 100 and a shutter eyewear 200 that configure a stereoscopic display system 10 according to a first embodiment of the present invention.

FIG. 2 is a functional block diagram illustrating an outline of a configuration of the stereoscopic display device 100 and the shutter eyewear 200 that configure the stereoscopic display system 10 shown in FIG. 1.

FIG. 3 is a block diagram illustrating a configuration of a brightness control section 300 for controlling a brightness level of an image in the stereoscopic display device 100 according to the first embodiment of the present invention.

FIG. 4 is a block diagram illustrating a configuration of an image characteristic determination unit 350.

FIG. 5 illustrates a method executed by a parameter number determination section 351 for determining a parameter number based on an APL outputted from an average level calculator 330.

FIG. 6 illustrates drive parameters corresponding to parameter numbers, and a relationship between an APL and brightness.

FIG. 7 illustrates drive parameters corresponding to parameter numbers, and a relationship between an APL and brightness.

FIG. 8 is a flow chart showing a flow of a process of a stereoscopic display method executed by the brightness control section 300 for controlling a brightness level of an image, in the stereoscopic display device 100 according to the first embodiment of the present invention.

FIG. 9 is a block diagram illustrating a configuration of a brightness control section 301 for controlling a brightness level of an image, in the stereoscopic display device 100 shown in FIG. 1 and FIG. 2.

FIG. 10 is a flow chart showing a flow of a process of a stereoscopic display method executed by the brightness control section 301 for controlling a brightness level of an image.

FIG. 11 is a block diagram illustrating a configuration of a brightness control section 302 for controlling a brightness level of an image, in the stereoscopic display device 100 shown in FIG. 1 and FIG. 2.

FIG. 12 illustrates a left eye image and a right eye image displayed by a stereoscopic display device.

FIG. 13 is a block diagram illustrating a configuration of a brightness control section 900 for controlling a brightness level of an image according to conventional arts.

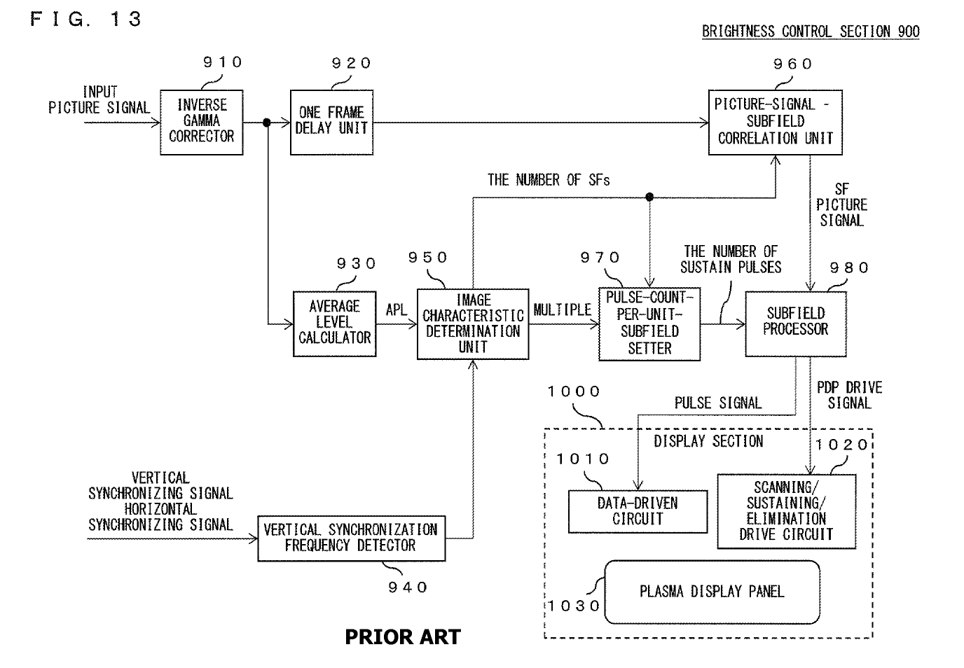

FIG. 14 illustrates a left eye image and a right eye image displayed by a stereoscopic display device.

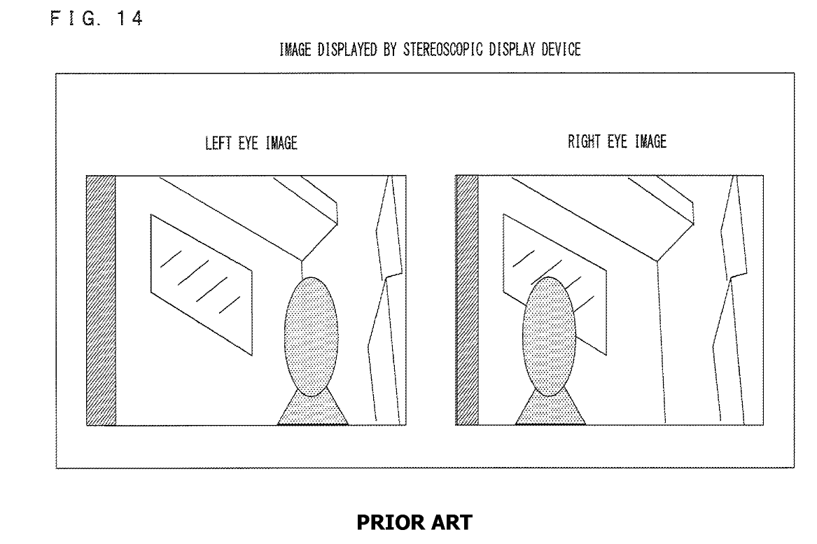

### DESCRIPTION OF EMBODIMENTS

Hereinafter, embodiments of the present invention will be described with reference to the drawings.

### First Embodiment

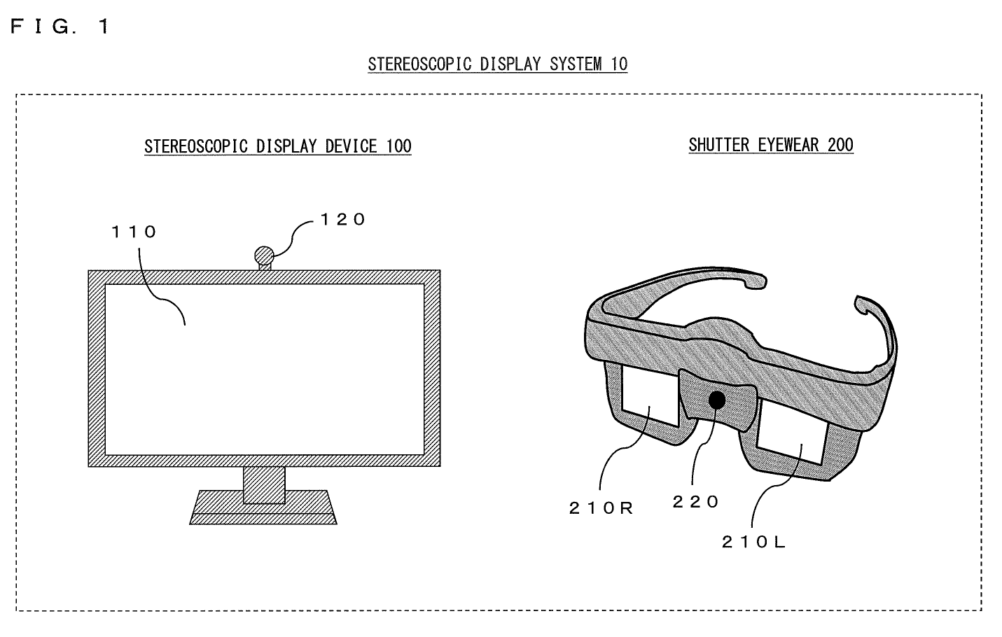

FIG. 1 is a perspective view of outlines of a stereoscopic display device 100 and a shutter eyewear 200 that configure a stereoscopic display system 10 according to a first embodiment of the present invention. As shown in FIG. 1, the stereoscopic display system 10 is configured with the stereoscopic display device 100 and the shutter eyewear 200.

The stereoscopic display device 100 includes a display section 110 and a transmission section 120. For example, the display section 110 is implemented as a PDP, and the transmission section 120 is implemented as an infrared light emitting element. On the display section 110, a left eye image and a right eye image are alternately displayed, and a synchronization signal representing a time at which shutters of the shutter eyewear 200 are to be switched is transmitted from the transmission section 120 to the shutter eyewear 200 in synchronization with the left eye image and the right eye image being displayed.

The shutter eyewear 200 includes a left eye shutter 210L, a right eye shutter 210R, and a reception section 220. For example, the reception section 220 is implemented as an infrared light receiving element. The reception section 220 receives a synchronization signal which is an infrared signal transmitted from the transmission section 120 of the stereoscopic display device 100. In the shutter eyewear 200, the left eye shutter 210L and the right eye shutter 210R are each controlled so as to open or close in synchronization with the left eye image and the right eye image which are alternately displayed on the display section 110 of the stereoscopic display device 100.

As described above, a user is allowed to view, through the shutter eyewear 200, an image displayed by the stereoscopic display device 100, so that the user is allowed to perceive the image as a stereoscopic image.

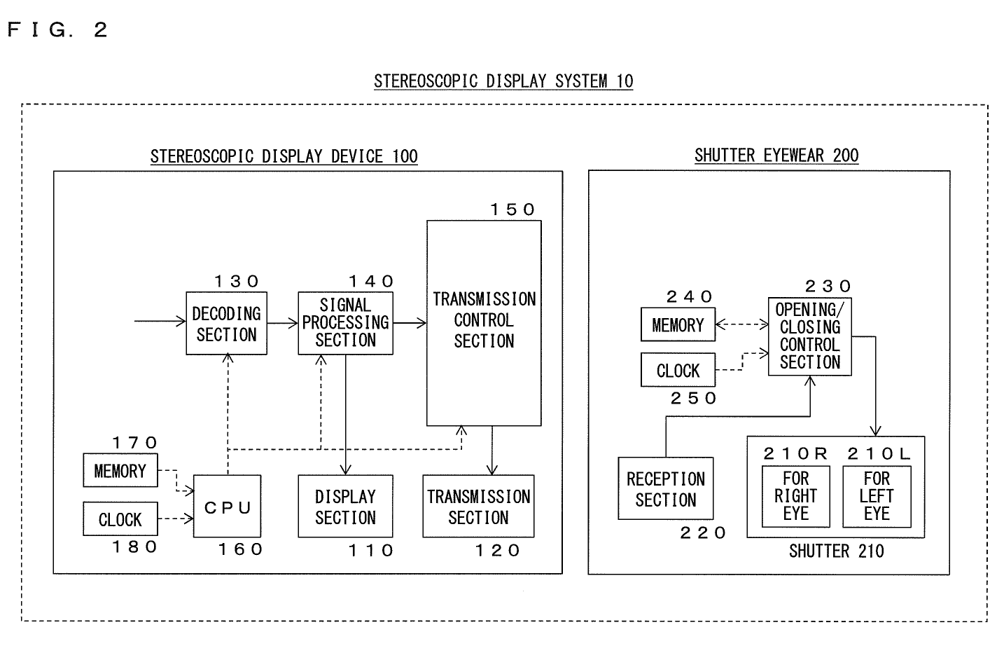

FIG. 2 is a functional block diagram illustrating an outline of a configuration of the stereoscopic display device 100 and the shutter eyewear 200 that configure the stereoscopic display system 10 shown in FIG. 1. In FIG. 2, the stereoscopic display device 100 includes the display section 110, the transmission section 120, a decoding section 130, a signal processing section 140, a transmission control section 150, a CPU (Central Processing Unit) 160, a memory 170, and a clock 180. The shutter eyewear 200 includes a shutter 210, the reception section 220, an opening/closing control section 230, a memory 240, and a clock 250. The shutter 210 includes the left eye shutter 210L and the right eye shutter 210R.

In the stereoscopic display device 100, a stereoscopic picture signal of an image which is taken with an angle of a parallax caused by a left eye and a right eye is inputted to the signal processing section 140 via the decoding section 130 together with a vertical synchronizing signal representing a time at which the stereoscopic picture signal is to be displayed. Further, for example, a stereoscopic picture signal generated by using computer graphics or the like may be inputted to the signal processing section 140 via the decoding section 130 together with a vertical synchronizing signal representing a time at which the stereoscopic picture signal is to be displayed.

The stereoscopic picture signal inputted to the signal processing section 140 is separated into a left eye image and a right eye image, and the left eye image and the right eye image are stored in a frame memory (not shown). The left eye image and the right eye image which are stored in the frame memory are read at a speed obtained by doubling a display frequency (frame frequency), and are alternately displayed on the display section 110.

The transmission control section 150 performs a control such that a synchronization signal representing a time at which shutters of the shutter eyewear 200 are to be switched is transmitted, through the transmission section 120, to the shutter eyewear 200, in synchronization with the left eye image and the right eye image being displayed.

The CPU 160 controls various functional sections based on various data stored in the memory 170, and a clock frequency from the clock 180.

The shutter eyewear 200 receives the synchronization signal transmitted from the stereoscopic display device 100, by using the reception section 220. The opening/closing control section 230 controls, based on the synchronization signal received by the reception section 220, each of the left eye shutter 210L and the right eye shutter 210R so as to open or close in synchronization with the left eye image and the right eye image which are alternately displayed on the display section 110 of the stereoscopic display device 100.

The opening/closing control section 230 controls the functional sections based on various data stored in the memory 240, and a clock frequency from the clock 250.

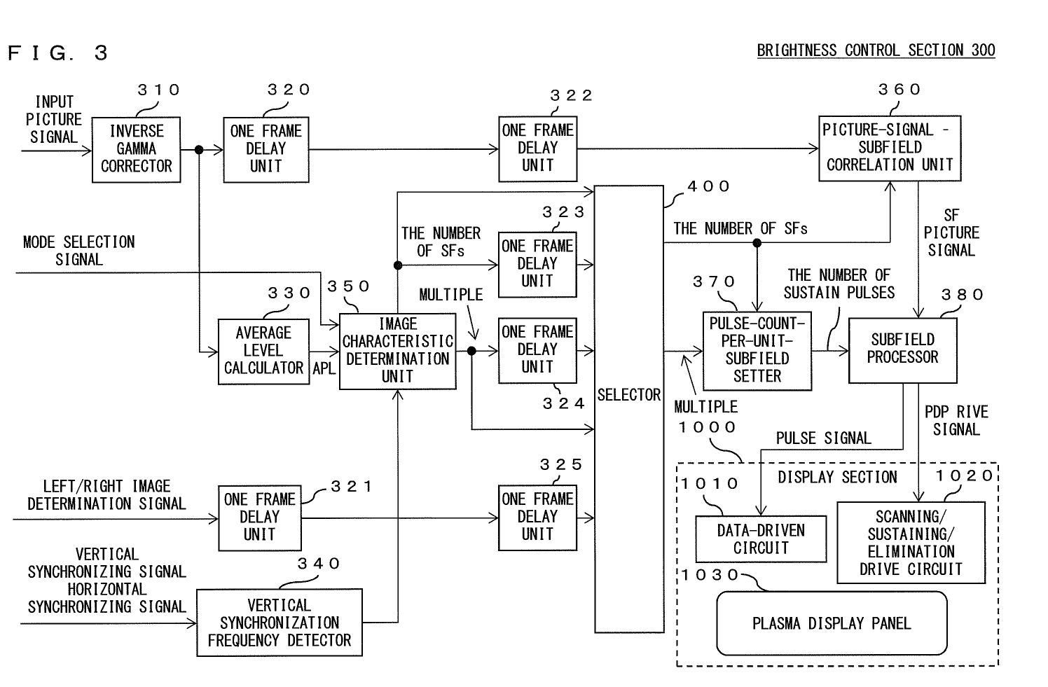

Next, a brightness control performed by the signal processing section 140 of the stereoscopic display device 100 shown in FIG. 2 for controlling brightness levels of the left eye image and the right eye image will be described in detail. FIG. 3 is a block diagram illustrating a configuration of a brightness control section 300 for controlling a brightness level of an image in the stereoscopic display device 100 according to the first embodiment of the present invention. In FIG. 3, the brightness control section 300 includes an inverse gamma corrector 310, one frame delay units 320 to 325, an average level calculator 330, a vertical synchronization frequency detector 340, an image characteristic determination unit 350, a picture-signal—subfield correlation unit 360, a pulse-count-per-unit-subfield setter 370, a subfield processor 380, and a selector 400.

The inverse gamma corrector 310 subjects, to an inverse gamma correction, R(RED), G(GREEN), and B(BLUE) input picture signals having been obtained by analog-to-digital (A/D) conversion. In the description herein, to the inverse gamma corrector 310, a left eye image of the N-th frame, a right eye image of the N-th frame, a left eye image of the (N+1)-th frame, and a right eye image of the (N+1)-th frame are inputted in order, respectively.

Simultaneously, a left/right image determination signal is inputted to the one frame delay unit 321, and is delayed therein by one frame period, further delayed in the one frame delay unit 325 by one frame period, and is outputted to the selector 400. Further, to the vertical synchronization frequency detector 340, a vertical synchronizing signal from an input terminal VD and a horizontal synchronizing signal from an input terminal HD are inputted.

The one frame delay unit 320 generates a picture signal by delaying, by one frame period, the picture signal outputted from the inverse gamma corrector 310, and outputs the generated picture signal to the one frame delay unit 322 provided subsequent thereto. The one frame delay unit 322 generates a picture signal by further delaying, by one frame period, the picture signal outputted from the one frame delay unit 320, and outputs the generated picture signal to the picture-signal—subfield correlation unit 360.

The average level calculator 330 calculates an APL based on the picture signal outputted by the inverse gamma corrector 310, and outputs the APL to the image characteristic determination unit 350.

The vertical synchronization frequency detector 340 detects a vertical synchronization frequency based on the vertical synchronizing signal from the input terminal VD and the horizontal synchronizing signal from the input terminal HD. A vertical synchronization frequency of a television signal is 60 Hz (standard frequency) in general, and a vertical synchronization frequency of a picture signal of a personal computer is a frequency (for example, 72 Hz) higher than the standard frequency. Therefore, in order to output a picture signal of a personal computer to a PDP, the vertical synchronization frequency needs to be adjusted. Therefore, when the vertical synchronization frequency detector 340 detects a vertical synchronization frequency higher than the standard frequency, the vertical synchronization frequency detector 340 outputs a signal representing the vertical synchronization frequency to the image characteristic determination unit 350.

The image characteristic determination unit 350 determines a drive parameter for the brightness control of an image, based on the APL outputted from the average level calculator 330. The drive parameters are SF counts and multiples which are established in association with parameter numbers and the vertical synchronization frequencies.

A method for determining the drive parameter will be described in detail.

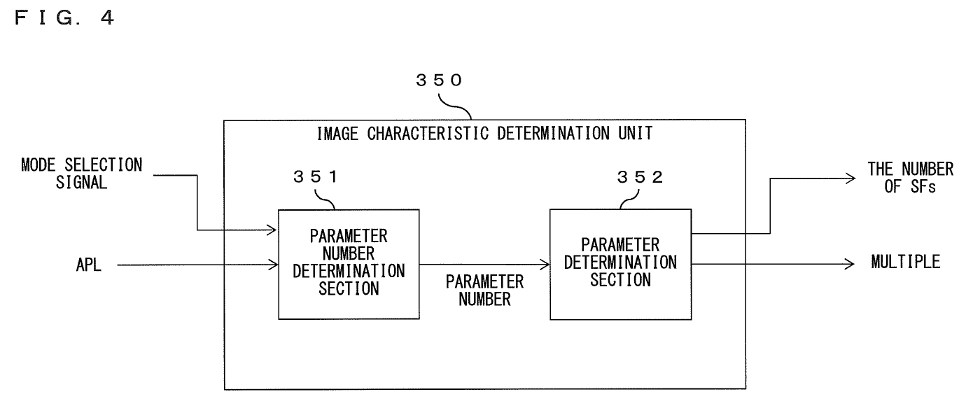

FIG. 4 is a block diagram illustrating a configuration of the image characteristic determination unit 350. In FIG. 4, the image characteristic determination unit 350 includes a parameter number determination section 351 and a parameter determination section 352. The parameter number determination section 351 determines a parameter number based on the APL outputted from the average level calculator 330, and outputs the parameter number to the parameter determination section 352.

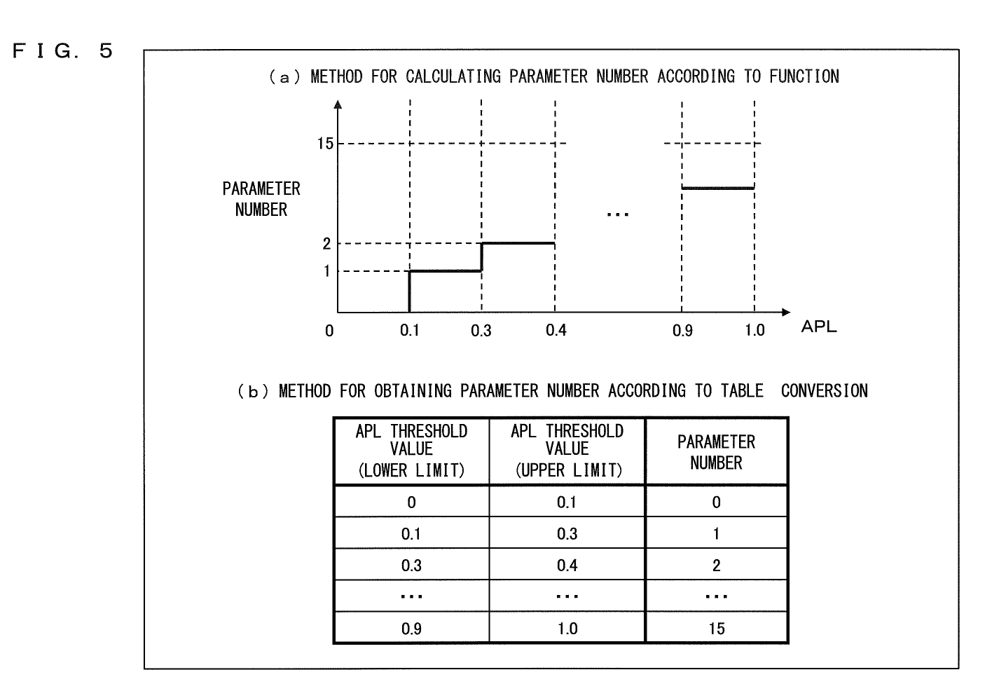

FIG. 5 illustrates a method executed by the parameter number determination section 351 for determining the parameter number based on the APL outputted from the average level calculator 330. FIG. 5(a) shows a method for calculating the parameter number according to a preset function based on the inputted APL. FIG. 5(b) shows a method for obtaining the parameter number corresponding to the inputted APL, by using a preset look-up table. In each of cases of FIGS. 5(a) and (b), when, for example, the inputted APL indicates “0.2”, “1” is determined as the parameter number.

The parameter determination section 352 determines a drive parameter for the brightness control of an image, based on the parameter number outputted from the parameter number determination section 351, and a signal which represents the vertical synchronization frequency, and which is outputted from the vertical synchronization frequency detector 340.

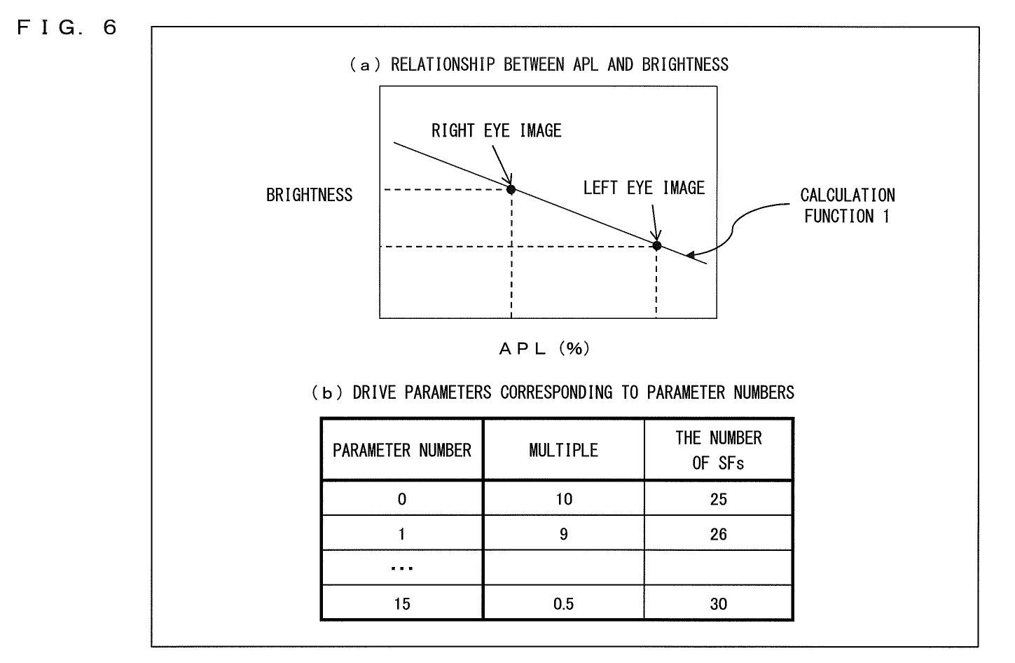

FIG. 6 illustrates: a relationship between the APL and brightness; and drive parameters (multiple and the number of SFs) corresponding to the parameter numbers. FIG. 6(a) shows a brightness calculation function (hereinafter, abbreviated as “calculation function 1”) in which the higher the APL is, the lower the brightness of an image is. When the input image is highly bright, a brightness degree with which the PDP emits light may be low. The calculation function 1 is preset so as to prevent occurrence of image corruption even if control is performed such that the brightness is high. FIG. 6(b) shows the drive parameters (multiple and the number of SFs) which are preset so as to correspond to the parameter numbers, based on the calculation function 1 shown in FIG. 6(a). As shown in FIG. 6(b), for example, when the parameter number represents “1”, the parameter determination section 352 determines the drive parameter such that the multiple is “9” and the number of SFs is “26” so as to correspond to the parameter number “1”.

As described above, the image characteristic determination unit 350 determines the number of SFs and the multiple as the drive parameter, outputs the number of SFs and the multiple to the one frame delay units 323 and 324, respectively, and outputs the number of SFs and the multiple to the selector 400. Although, in the description herein, the parameter determination section 352 determines the number of SFs and the multiple by using the look-up table which is previously stored in storage means (not shown) such as a memory, the number of SFs and the multiple may be obtained according to a calculation formula.

Further, although, in the description herein, the image characteristic determination unit 350 determines the parameter number by using the parameter number determination section 351, and determines the drive parameter corresponding to the parameter number by using the parameter determination section 352, the drive parameter corresponding to the inputted APL may be directly calculated.

Further, the drive parameter may be determined with reference to a mode selection signal representing a used mode. In the description herein, the mode selection signal contains, for example, information representing a power saving mode for reducing power consumption, an image enhancement mode for enhancing an image for display, and the like, and these modes are set according to an operation performed by a user or an automatic setting. The used mode may be preset by using, for example, a push button (not shown) provided in the stereoscopic display device 100. Further, the power saving mode may be set as an initial value.

The selector 400 receives, from the one frame delay units 323 and 324, the number of SFs and the multiple obtained by delay of one frame period in the one frame delay units 323 and 324, respectively, and receives the number of SFs and the multiple from the image characteristic determination unit 350. In the description herein, a left eye image of the N-th frame, a right eye image of the N-th frame, a left eye image of the (N+1)-th frame, and a right eye image of the (N+1)-th frame are inputted in order, respectively. Therefore, to the selector 400, the number of SFs and the multiple for the left eye image of the N-th frame are inputted from the one frame delay units 323 and 324, respectively, and the number of SFs and the multiple for the right eye image of the N-th frame are inputted from the image characteristic determination unit 350.

The selector 400 compares the number of SFs and the multiple between the left eye image of the N-th frame and the right eye image of the N-th frame, and selects the number of SFs and the multiple for one of the left eye image or the right eye image. As shown in FIG. 6(a), in the case of the calculation function 1, when the input image is highly bright, the brightness degree with which the PDP emits light may be low. For example, as shown in FIG. 6(a), when the APL of the left eye image is higher than the APL of the right eye image, the multiple for the left eye image is less than the multiple for the right eye image. In this case, the selector 400 selects the drive parameter (the number of SFs and the multiple) of the left eye image.

The selector 400 outputs the number of SFs (in this case, the number of SFs of the left eye image) having been selected, to the picture-signal—subfield correlation unit 360 and the pulse-count-per-unit-subfield setter 370, and outputs the multiple (in this case, the multiple for the left eye image) having been selected, to the pulse-count-per-unit-subfield setter 370.

The picture-signal—subfield correlation unit 360 generates a subfield picture signal, based on the picture signal of the left eye image which is outputted from the one frame delay unit 322, and the number of SFs of the left eye image which is outputted from the selector 400, and outputs the subfield picture signal to the subfield processor 380.

The pulse-count-per-unit-subfield setter 370 sets the number of sustain pulses required for each subfield, based on the multiple for the left eye image which is outputted from the selector 400, and outputs the number of sustain pulses to the subfield processor 380.

The subfield processor 380 generates a PDP drive signal based on the subfield picture signal outputted from the picture-signal—subfield correlation unit 360, and generates a pulse signal based on the number of sustain pulses which is outputted from the pulse-count-per-unit-subfield setter 370. The pulse signal is set in consideration of a set-up period, a writing period, and a sustaining period.

The display section 1000 includes a data-driven circuit 1010, a scanning/sustaining/elimination drive circuit 1020, and a plasma display panel 1030. The PDP drive signal outputted from the subfield processor 380 is inputted to the data-driven circuit 1010, and the pulse signal outputted from the subfield processor 380 is inputted to the scanning/sustaining/elimination drive circuit 1020, to display the left eye image having its brightness controlled, on the plasma display panel 1030.

Next, a process for the right eye image will be described. In a similar manner as in the process for the left eye image, the selector 400 selects the drive parameter (the number of SFs and the multiple) of the left eye image, and outputs the number of SFs of the left eye image to the picture-signal—subfield correlation unit 360 and the pulse-count-per-unit-subfield setter 370, and outputs the multiple for the left eye image to the pulse-count-per-unit-subfield setter 370. In other words, the selector 400 may operate once in every two frames based on the left/right image determination signal. Specifically, the selector 400 may be set to operate when the left/right image determination signal indicates “1” in the case of the input picture signal starting with the left eye image, and may be set to operate when the left/right image determination signal indicates “0” in the case of the input picture signal starting with the right eye image.

The picture-signal—subfield correlation unit 360 generates a subfield picture signal based on the picture signal of the right eye image which is outputted from the one frame delay unit 322, and the number of SFs of the left eye image which is outputted from the selector 400, and outputs the subfield picture signal to the subfield processor 380.

The pulse-count-per-unit-subfield setter 370 sets the number of sustain pulses required for each subfield, based on the multiple for the left eye image which is outputted from the selector 400, and outputs the number of sustain pulses to the subfield processor 380.

The subfield processor 380 generates a PDP drive signal based on the subfield picture signal outputted from the picture-signal—subfield correlation unit 360, and generates a pulse signal based on the number of sustain pulses which is outputted from the pulse-count-per-unit-subfield setter 370.

The PDP drive signal outputted from the subfield processor 380 is inputted to the data-driven circuit 1010, and the pulse signal outputted from the subfield processor 380 is inputted to the scanning/sustaining/elimination drive circuit 1020, to display the right eye image having its brightness controlled, on the plasma display panel 1030.

As described above, in the brightness control section 300 of the stereoscopic display device 100 according to the first embodiment of the present invention, the left eye image and the right eye image are controlled based on the drive parameter (the number of SFs and the multiple) of the left eye image, so that a high-quality stereoscopic display can be realized so as to reduce a variation between the left eye image and the right eye image, and enable an excellent viewability.

Further, as shown in FIG. 6(a), in a case where the higher the APL is, the lower the brightness of an image is, the drive parameter of the left eye image having a lower brightness is selected, so that, while occurrence of image corruption caused by a high brightness can be prevented, power consumption of the stereoscopic display device 100 can be reduced.

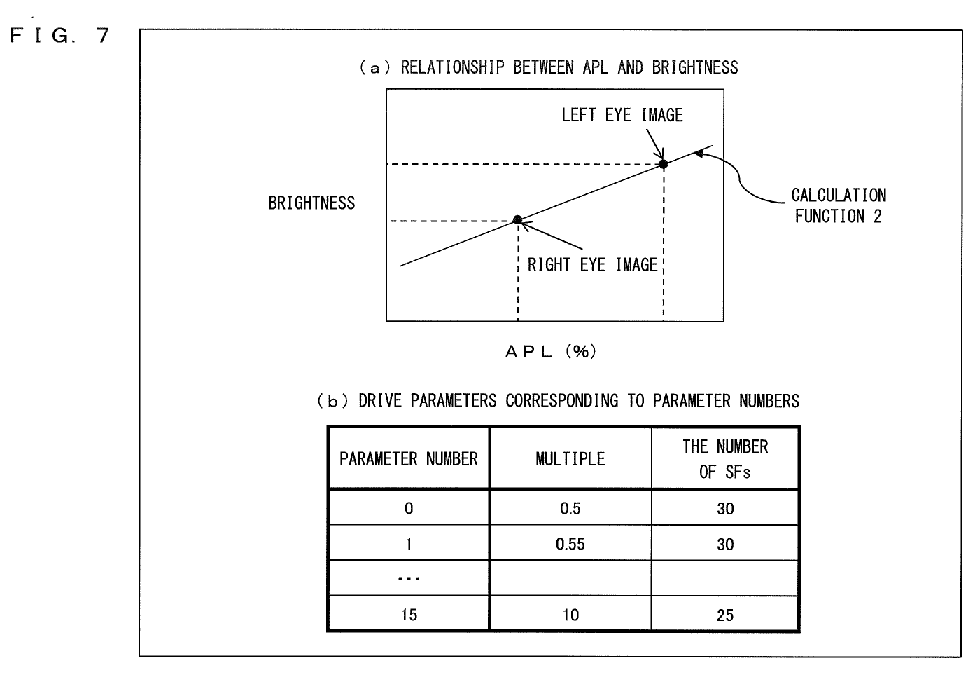

A case in which, as shown in FIG. 6(a), the higher the APL is, the lower the brightness of the image is, is described above. A case in which the higher the APL is, the higher the brightness of the image is, will be described below. FIG. 7 illustrates: a relationship between an APL and a brightness; and drive parameters (multiple and the number of SFs) corresponding to the parameter numbers. FIG. 7(a) shows a brightness calculation function (hereinafter, abbreviated as “calculation function 2”) in which the higher the APL is, the higher the brightness of the image is. When an input image is highly bright, a brightness degree with which the PDP emits light is high, so that the image is enhanced and an impact is enhanced. However, the calculation function 2 is preset so as to prevent occurrence of image corruption even when control is performed such that the brightness is high. FIG. 7(b) shows the drive parameters (the multiple and the number of SFs) which are preset so as to correspond to the parameter numbers, based on the calculation function 2 shown in FIG. 7(a). As shown in FIG. 7(b), for example, when the parameter number represents “1”, the parameter determination section 352 determines the drive parameter such that the multiple is “0.55” and the number of SFs is “30” so as to correspond to the parameter number “1”.

The selector 400 compares the number of SFs and the multiple between the left eye image of the N-th frame and the right eye image of the N-th frame, and selects the number of SFs and the multiple for one of the left eye image or the right eye image. In this case, the selector 400 may select the number of SFs and the multiple for one of either the left eye image or the right eye image, with reference to the mode selection signal representing a used mode. The mode selection signal contains, for example, information representing the power saving mode for reducing power consumption, the image enhancement mode for enhancing an image for display, and the like, and these modes are set according to an operation performed by a user or an automatic setting.

For example, as shown in FIG. 7(a), when the APL of the left eye image is higher than the APL of the right eye image, the multiple for the left eye image is greater than the multiple for the right eye image. When the mode selection signal contains the information representing the image enhancement mode, the selector 400 selects the drive parameter (the number of SFs and the multiple) of the left eye image.

Thus, the left eye image and the right eye image each having its brightness controlled by using the drive parameter (the number of SFs and the multiple) of the left eye image are displayed on the plasma display panel 1030. As a result, a high-quality stereoscopic display can be realized so as to reduce a variation between the left eye image and the right eye image, and enable an excellent viewability. Further, while occurrence of image corruption caused by a high brightness can be prevented, a brightness of the other of the images is enhanced, so that a stereoscopic display can be realized so as to enhance the image and enhance an impact.

On the other hand, when the mode selection signal contains the information representing the power saving mode, the selector 400 selects the drive parameter (the number of SFs and the multiple) of the right eye image.

Thus, the left eye image and the right eye image each having its brightness controlled by using the drive parameter (the number of SFs and the multiple) of the right eye image are displayed on the plasma display panel 1030. As a result, a high-quality stereoscopic display can be realized so as to reduce a variation between the left eye image and the right eye image, and enable an excellent viewability. Further, a brightness of the other of the images is restricted, so that the power consumption of the stereoscopic display device 100 can be reduced.

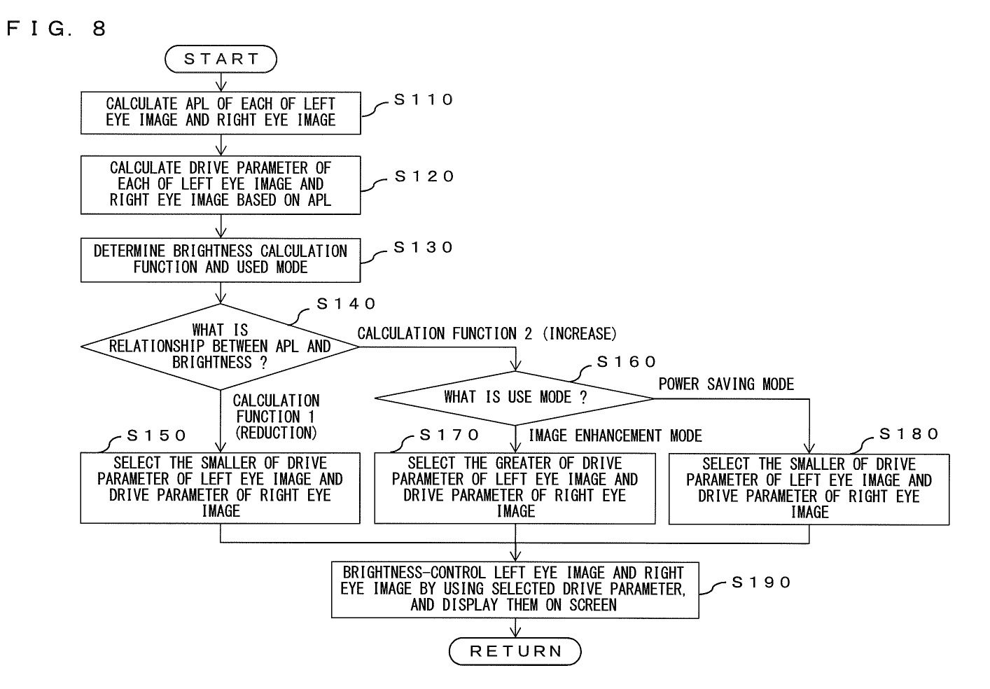

Next, a flow of a process of the stereoscopic display method executed by the stereoscopic display device according to the first embodiment of the present invention will be described in detail. FIG. 8 is a flow chart showing a flow of the process of the stereoscopic display method executed by the brightness control section 300 for controlling a brightness level of an image, in the stereoscopic display device 100 according to the first embodiment of the present invention.

In step S110, the average level calculator 330 calculates an APL of each of the left eye image and the right eye image based on the picture signal outputted from the inverse gamma corrector 310.

In step S120, the image characteristic determination unit 350 calculates the drive parameters of the left eye image and the right eye image, based on the APLs of the left eye image and the right eye image, respectively, calculated in step S110. Specifically, the drive parameter of each of the left eye image and the right eye image is calculated as described above with reference to FIG. 5 to FIG. 7.

In step S130, the selector 400 compares the drive parameter calculated in step S120 between the left eye image and the right eye image, and determines the preset brightness calculation function and the used mode. Specifically, whether the brightness calculation function is the calculation function 1 or the calculation function 2 shown in FIG. 5 and FIG. 6 is determined, and whether the used mode is the power saving mode or the image enhancement mode is determined according to the mode selection signal.

When the selector 400 determines in step S140 that the relationship between the APL and the brightness indicates that the higher the APL is, the lower the brightness of the image is (when the brightness calculation function is the calculation function 1), the process is advanced to step S150. In step S150, the selector 400 selects a drive parameter for reducing the brightness, from among the drive parameters calculated in step S120 for the left eye image and the right eye image.

On the other hand, when the selector 400 determines in step S140 that the relationship between the APL and the brightness indicates that the higher the APL is, the higher the brightness of the image is (when the brightness calculation function is the calculation function 2), the process is advanced to step S160.

When the selector 400 determines in step S160 that the used mode is the image enhancement mode, the process is advanced to step S170. In step S170, the selector 400 selects a drive parameter for increasing the brightness, from among the drive parameters calculated in step S120 for the left eye image and the right eye image.

When the selector 400 determines in step S160 that the used mode is the power saving mode, the process is advanced to step S180. In step S180, the selector 400 selects a drive parameter for reducing the brightness, from among the drive parameters calculated in step S120 for the left eye image and the right eye image.

Finally, in step S190, the picture-signal—subfield correlation unit 360, the pulse-count-per-unit-subfield setter 370, and the subfield processor 380 brightness-control the picture signal of the left eye image and the picture signal of the right eye image, based on the drive parameter selected in step S150, step S160, or step S180, for display on the display.

As described above, in the stereoscopic display method executed by the brightness control section 300 of the stereoscopic display device 100 according to the first embodiment of the present invention, the left eye image and the right eye image are controlled according to the drive parameter (the number of SFs and the multiple) of the left eye image, so that a high-quality stereoscopic display can be realized so as to reduce a variation between the left eye image and the right eye image, and enable an excellent viewability. Further, the drive parameter is selected according to the used mode and the relationship between the APL and the brightness, so that while occurrence of image corruption caused by a high brightness can be prevented, the image can be enhanced and an impact can be enhanced, or the power consumption of the stereoscopic display device 100 can be reduced.

### Second Embodiment

In a second embodiment of the present invention, a stereoscopic display system in which an APL of the left eye image of the N-th frame, and an APL of the right eye image of the N-th frame are compared with each other, to select one of the APLs, and thereafter the drive parameter is calculated based on the selected APL, will be described. A fundamental configuration of the stereoscopic display system according to the second embodiment of the present invention is the same as that of the stereoscopic display system 10, shown in FIG. 1 and FIG. 2, according to the first embodiment of the present invention.

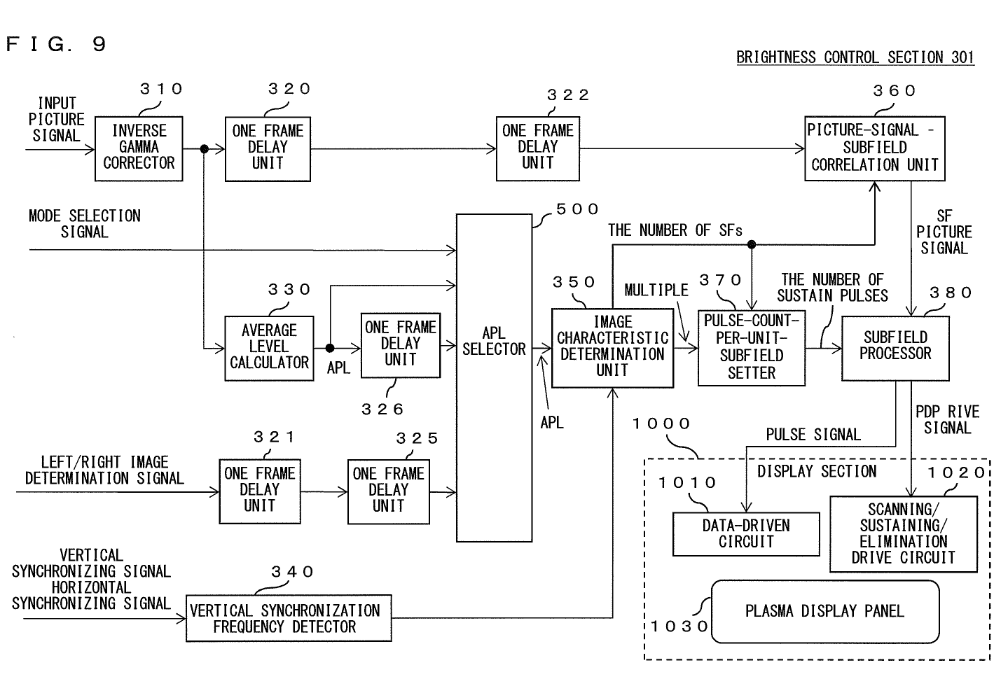

FIG. 9 is a block diagram illustrating a configuration of a brightness control section 301 for controlling a brightness level of an image, in the stereoscopic display device 100 shown in FIG. 1 and FIG. 2. In FIG. 9, the brightness control section 301 includes the inverse gamma corrector 310, one frame delay units 320 to 322 and 325 to 326, the average level calculator 330, the vertical synchronization frequency detector 340, the image characteristic determination unit 350, the picture-signal—subfield correlation unit 360, the pulse-count-per-unit-subfield setter 370, the subfield processor 380, and an average picture signal level (APL) selector 500.

As shown in FIG. 9, the brightness control section 301 according to the present embodiment has a characteristic that the brightness control section 301 has the APL selector 500 provided preceding the image characteristic determination unit 350, instead of the selector 400 of the brightness control section 300 being provided as shown in FIG. 3 in the first embodiment of the present invention. For the brightness control section 301, the same components as those of the brightness control section 300 according to the first embodiment of the present invention are denoted by the same corresponding reference numerals, and the detailed description thereof is not given. In the present embodiment, difference from the first embodiment of the present invention will be described in detail.

The average level calculator 330 calculates an APL based on the picture signal outputted by the inverse gamma corrector 310, and outputs the APL to the one frame delay unit 326 and the APL selector 500. In the description herein, a left eye image of the N-th frame, a right eye image of the N-th frame, a left eye image of the (N+1)-th frame, and a right eye image of the (N+1)-th frame are inputted in order, respectively. Therefore, to the APL selector 500, the APL of the left eye image of the N-th frame is inputted from the one frame delay unit 326, and the APL of the right eye image of the N-th frame is inputted from the average level calculator 330.

The APL selector 500 receives, via the one frame delay unit 326, the APL of the left eye image which is delayed by one frame period, and receives the APL of the right eye image which is inputted from the average level calculator 330. The APL selector 500 selects one of the APL of the left eye image and the APL of the right eye image, based on the relationship between the APL and the brightness as described in the first embodiment of the present invention with reference to FIG. 6(a) and FIG. 7(a), and the used mode represented by the mode selection signal.

The APL selector 500 may operate once in every two frames based on the left/right image determination signal. Specifically, the APL selector 500 may be set to operate when the left/right image determination signal represents “1” in the case of the input picture signal starting with the left eye image, and the APL selector 500 may be set to operate when the left/right image determination signal represents “0” in the case of the input picture signal starting with the right eye image.

The image characteristic determination unit 350 determines the drive parameter based on the APL selected by the APL selector 500. For example, when the APL of the left eye image is selected, by the APL selector 500, from among the APL of the left eye image and the APL of the right eye image, the image characteristic determination unit 350 determines the drive parameter based on the APL of the left eye image. The image characteristic determination unit 350 may include the parameter number determination section 351 and the parameter determination section 352 as shown in FIG. 4, and may determine the parameter number as shown in FIG. 5. Then, as shown in FIG. 6(b) or FIG. 7(b), the drive parameter (the multiple and the number of SFs) corresponding to the parameter number may be determined.

The picture-signal—subfield correlation unit 360, the pulse-count-per-unit-subfield setter 370, and the subfield processor 380 brightness-control the picture signal of the left eye image and the picture signal of the right eye image, based on the drive parameter (the multiple and the number of SFs) determined by the image characteristic determination unit 350.

Thus, the left eye image and the right eye image each having its brightness controlled by using the drive parameter (the number of SFs and the multiple) determined based on the APL selected by the APL selector 500 are displayed on the plasma display panel 1030. As a result, a high-quality stereoscopic display can be realized so as to reduce a variation between the left eye image and the right eye image, and enable an excellent viewability. Further, the drive parameter is selected according to the relationship between the APL and the brightness, and the used mode, so that while occurrence of image corruption caused by a high brightness can be prevented, the image can be enhanced and an impact can be enhanced, or power consumption of the stereoscopic display device can be reduced.

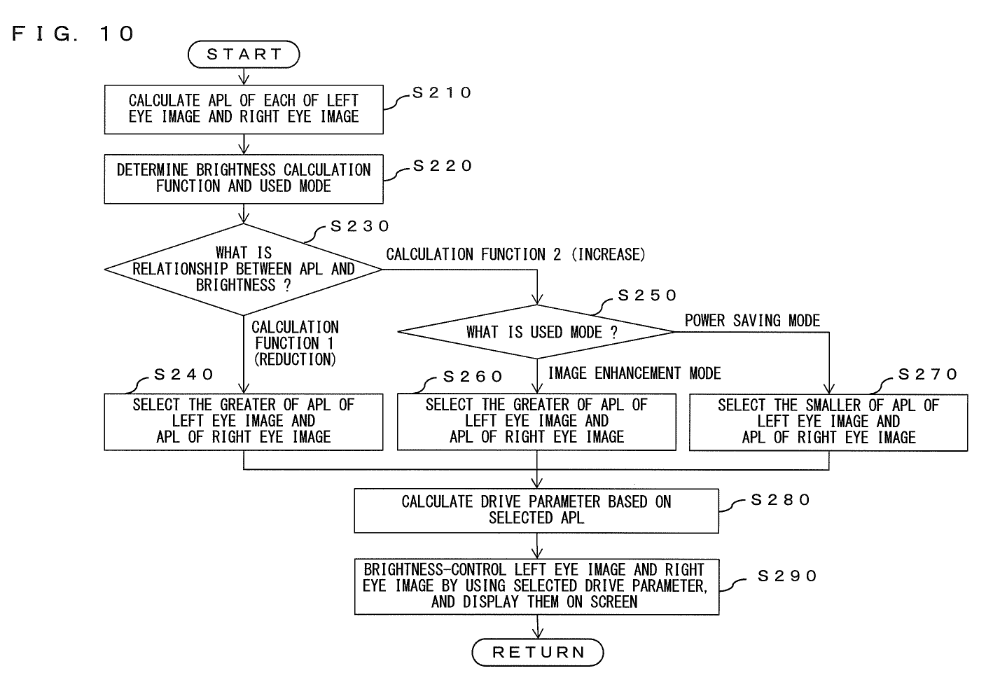

Next, a flow of a process of a stereoscopic display method executed by the stereoscopic display device according to the second embodiment of the present invention will be described in detail. FIG. 10 is a flow chart showing a flow of the process of the stereoscopic display method executed by the brightness control section 301 for controlling a brightness level of an image.

In step S210, the average level calculator 330 calculates an APL of each of the left eye image and the right eye image, based on the picture signal outputted by the inverse gamma corrector 310.

In step S220, the APL selector 500 compares between the APL of the left eye image and the APL of the right eye image which are calculated in step S210, and determines a preset brightness calculation function and a used mode. Specifically, whether the brightness calculation function is the calculation function 1 or the calculation function 2 as shown in FIG. 5 and FIG. 6 is determined, and whether the used mode is the power saving mode or the image enhancement mode is determined with reference to the mode selection signal.

When the APL selector 500 determines in step S230 that the relationship between the APL and the brightness indicates that the higher the APL is, the lower the brightness of the image is (when the brightness calculation function is the calculation function 1), the process is advanced to step S240. In step S240, the APL selector 500 selects the higher of the APL of the left eye image or the APL of the right eye image as calculated in step S210.

On the other hand, when the APL selector 500 determines in step S230 that the relationship between the APL and the brightness indicates that the higher the APL is, the higher the brightness of an image is (when the brightness calculation function is the calculation function 2), the process is advanced to step S250.

When the APL selector 500 determines in step S250 that the used mode is the image enhancement mode, the process is advanced to step S260. In step S260, the APL selector 500 selects the higher of the APL of the left eye image or the APL of the right eye image as calculated in step S120.

When the APL selector 500 determines in step S250 that the used mode is the power saving mode, the process is advanced to step S270. In step S270, the APL selector 400 selects the lower of the APL of the left eye image or the APL of the right eye image as calculated in step S210.

In step S280, the image characteristic determination unit 350 calculates a drive parameter based on the APL selected in step S240, step S260, or step S270. Specifically, the drive parameter is calculated as described above with reference to FIG. 5 to FIG. 7.

Finally, in step S290, the picture-signal—subfield correlation unit 360, the pulse-count-per-unit-subfield setter 370, and the subfield processor 380 brightness-control the picture signal of the left eye image and the picture signal of the right eye image, based on the drive parameter calculated in step S280, for display on the display.

As described above, in the stereoscopic display method executed by the brightness control section 301 of the stereoscopic display device according to the second embodiment of the present invention, the left eye image and the right eye image are controlled according to the drive parameter (the number of SFs and the multiple) which is calculated based on one of the APL of the left eye image or the APL of the right eye image, so that a high-quality stereoscopic display can be realized so as to reduce a variation between the left eye image and the right eye image, and enable an excellent viewability. Further, the APL is selected according to the relationship between the APL and the brightness, and the used mode, so that while occurrence of image corruption caused by a high brightness can be prevented, the image can be enhanced and an impact can be enhanced, or power consumption of the stereoscopic display device can be reduced.

### Third Embodiment

In a third embodiment of the present invention, a stereoscopic display system in which an APL of the left eye image of the N-th frame and an APL of the right eye image of the N-th frame are compared with each other, to select one of the APLs, and thereafter a drive parameter is calculated based on the selected APL, will be described. A fundamental configuration of the stereoscopic display system according to the second embodiment of the present invention is the same as that of the stereoscopic display system 10, shown in FIG. 1 and FIG. 2, according to the first embodiment of the present invention.

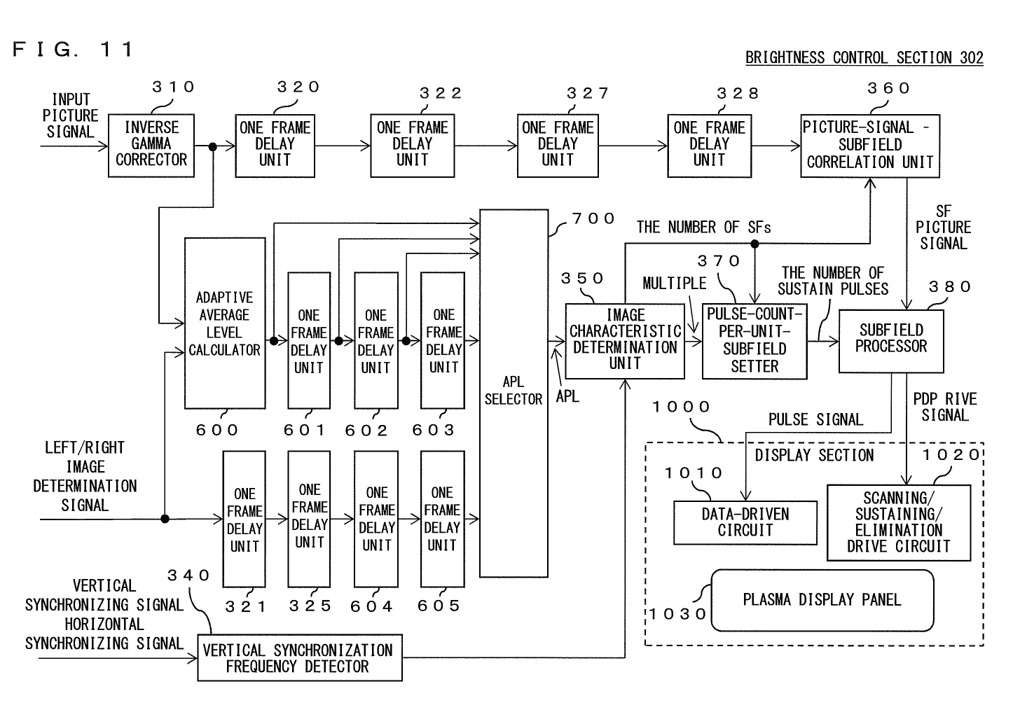

FIG. 11 is a block diagram illustrating a configuration of a brightness control section 302 for controlling a brightness level of an image, in the stereoscopic display device 100 shown in FIG. 1 and FIG. 2. In FIG. 11, the brightness control section 302 includes the inverse gamma corrector 310, one frame delay units 320 to 322, 325, 327 to 328, and 601 to 605, an adaptive average level calculator 600, the vertical synchronization frequency detector 340, the image characteristic determination unit 350, the picture-signal—subfield correlation unit 360, the pulse-count-per-unit-subfield setter 370, the subfield processor 380, and an average picture signal level (APL) selector 700. In the description herein, the mode selection signal shown in FIG. 3 and FIG. 9 is not illustrated.

As shown in FIG. 11, the brightness control section 302 according to the present embodiment has a characteristic that the brightness control section 302 has the adaptive average level calculator 600, instead of the average level calculator 330 of the brightness control section 301 being provided as shown in FIG. 9 in the second embodiment of the present invention. The one frame delay units 601 to 603 for delaying the APL calculated by the adaptive average level calculator 600, by one frame period, in order, respectively, are provided between the adaptive average level calculator 600 and the APL selector 700, and the one frame delay units 321, 325, and 604 to 605 for delaying an inputted left/right image determination signal, by one frame period in order, respectively, are similarly provided preceding the APL selector 700. For the brightness control section 302, the same components as those of the brightness control section 300 according to the first embodiment of the present invention and the brightness control section 301 according to the second embodiment of the present invention are denoted by the same corresponding reference numerals as in the first and the second embodiments, and the detailed description thereof is not given. In the present embodiment, difference from the first and the second embodiments of the present invention will be described in detail.

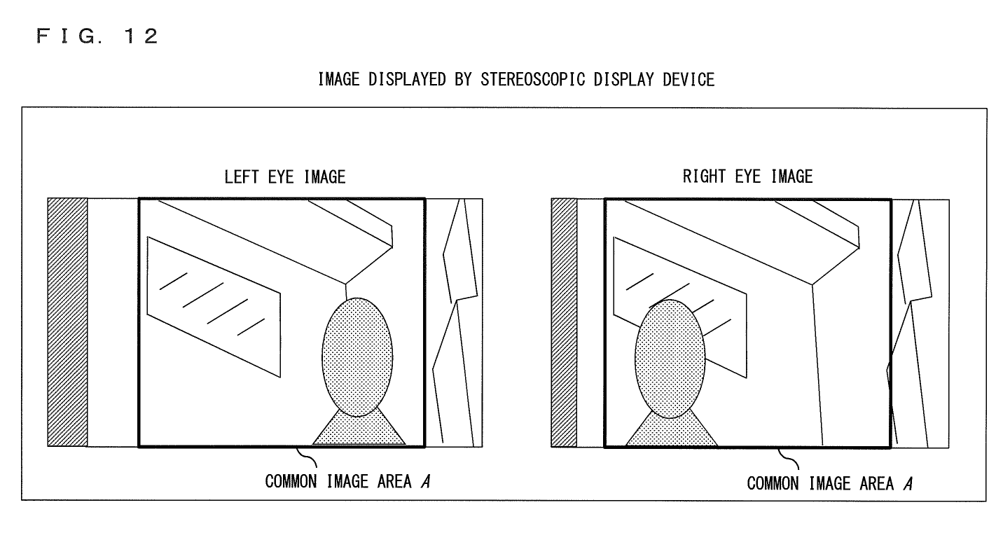

The adaptive average level calculator 600 calculates an APL of a left eye image and an APL of a right eye image for a common image area common to the left eye image and the right eye image, and outputs the APLs to the one frame delay unit 601 and the APL selector 700. The common image area represents central image areas of the left eye image and the right eye image, and does not include areas on both end portions of each of the left eye image and the right eye image. FIG. 12 illustrates the left eye image and the right eye image displayed by the stereoscopic display device. Specifically, for example, the adaptive average level calculator 600 calculates an APL of a common image area A, shown in FIG. 12, of each of the left eye image and the right eye image.

The one frame delay unit 601 delays, by one frame period, the APL of each common image area which is outputted from the adaptive average level calculator 600, and outputs the delayed APL to the one frame delay unit 602 provided subsequent thereto, and the APL selector 700.

The one frame delay unit 602 further delays, by one frame period, the APL of the common image area which is outputted from the one frame delay unit 601, and outputs the delayed APL to the one frame delay unit 603 provided subsequent thereto, and the APL selector 700.

The one frame delay unit 603 further delays, by one frame period, the APL of the common image area which is outputted from the one frame delay unit 602, and outputs the delayed APL to the APL selector 700.

The APL selector 700 calculates, based on the APLs of the common image areas of the left eye images of a plurality of frames as calculated by the adaptive average level calculator 600, a statistical APL of the left eye image which is, for example, an average of the plurality of APLs. Further, similarly, the APL selector 700 calculates, based on the APLs of the common image areas of the right eye images of a plurality of frames as calculated by the adaptive average level calculator 600, a statistical APL of the right eye image which is, for example, an average of the plurality of APLs. The APL selector 700 selects one of the statistical APL of the left eye image and the statistical APL of the right eye image, based on the relationship between the APL and the brightness as described in the first embodiment of the present invention with reference to FIG. 6(a) and FIG. 7(a), and the used mode represented by the mode selection signal.

The APL selector 700 may operate once in every two frames based on the left/right image determination signal. Specifically, the APL selector 700 may be set to operate when the left/right image determination signal represents “1” in the case of the input picture signal starting with a left eye image, and the APL selector 700 may be set to operate when the left/right image determination signal represents “0” in the case of the input picture signal starting with a right eye image.

The image characteristic determination unit 350 determines the drive parameter based on the statistical APL selected by the APL selector 700. Specifically, the drive parameter is calculated as described above with reference to FIG. 5 to FIG. 7.

The picture-signal—subfield correlation unit 360, the pulse-count-per-unit-subfield setter 370, and the subfield processor 380 brightness-control the picture signal of the left eye image and the picture signal of the right eye image, based on the drive parameter (the multiple and the number of SFs) determined by the image characteristic determination unit 350. In other words, the plurality of the left eye images and the plurality of right eye images which are used for calculating the statistical APL of the left eye image and the statistical APL of the right eye image, are brightness-controlled based on the one drive parameter.

As described above, in the brightness control section 302 of the stereoscopic display device and the stereoscopic display method executed by the brightness control section 302 according to the third embodiment of the present invention, the statistical APLs are calculated according to the APLs of a plurality of left eye images and a plurality of right eye images for the common image area, and each of the plurality of left eye images and the plurality of right eye images are temporally continuous. Further, the plurality of left eye images and the plurality of right eye images are controlled according to the drive parameter (the number of SFs and the multiple) calculated based on one of the statistical APL of the left eye image or the statistical APL of the right eye image. Therefore, a high-quality stereoscopic display can be realized so as to reduce a variation between the left eye image and the right eye image, further reduce a variation relative to a time axis, and enable an excellent viewability.

In the present embodiment, the brightness control section 302 shown in FIG. 11 has three one frame delay units, that is, the one frame delay units 601 to 603, provided between the adaptive average level calculator 600 and the APL selector 700, and has four one frame delay units, that is, the one frame delay units 321, 325, and 604 to 605, for delaying the left/right image determination signal by one frame period in order, respectively. Therefore, the APL selector 700 calculates the statistical APL of the left eye image based on the left eye images of two frames, and calculates the statistical ASL of the right eye image based on the right eye images of two frames. When the number of the one frame delay units provided is further increased, the statistical APL of the left eye image and the statistical APL of the right eye image can be calculated based on the left eye images of multiple frames and the right eye images of multiple frames. As a result, change of the brightness can be alleviated even when an image steeply varies, and a high-quality stereoscopic display can be realized so as to reduce a variation between the left eye image and the right eye image, reduce a variation relative to a time axis, and enable an excellent viewability.

In the first to the third embodiments of the present invention, the right eye image is displayed following the left eye image to perform a stereoscopic display. However, the same process can be performed also when the left eye image is displayed following the right eye image.

Further, in the first to the third embodiments of the present invention, a PDP is used as display means. However, needless to say, the brightness control can be performed in the same manner for another display means.

### INDUSTRIAL APPLICABILITY

The present invention is useful for, for example, a stereoscopic display device for alternately displaying a left eye image and a right eye image, to display a stereoscopic image.

### DESCRIPTION OF THE REFERENCE CHARACTERS

10 stereoscopic display system
100 stereoscopic display device
110 display section
120 transmission section
130 decoding section
140 signal processing section
150 transmission control section
160 CPU
170, 240 memory
180, 250 clock
200 shutter eyewear
210, 210L, 210R shutter
220 reception section
230 opening/closing control section
300, 301, 302, 900 brightness control section
310, 910 inverse gamma corrector
320 to 328, 601 to 605, 920 one frame delay unit
330, 930 average level calculator
340, 940 vertical synchronization frequency detector
350, 950 image characteristic determination unit
351 parameter number determination section
352 parameter determination section
360, 960 picture-signal—subfield correlation unit
370, 970 pulse-count-per-unit-subfield setter
380, 980 subfield processor
400 selector
500, 700 average picture signal level (APL) selector
600 adaptive average level calculator
1000 display section
1010 data-driven circuit
1020 scanning/sustaining/elimination drive circuit
1030 plasma display panel (PDP)

1. A stereoscopic display device for displaying left-eye and right-eye images in alternation on a display to show the images as a stereoscopic image, the stereoscopic display device comprising:
an average picture-signal level calculation section configured to calculate an average picture-signal levels of the left-eye images and the right-eye images, respectively;
a drive parameter calculation section configured to calculate drive parameters, corresponding to the respective average picture-signal levels calculated by the average picture signal-level calculation section, for showing the image stereoscopically;
a selection section configured to select one of either the drive parameter corresponding to the average picture-signal level of the left-eye image or the drive parameter corresponding to the average picture-signal level of the right-eye image, calculated by the drive parameter calculation section; and
a control section configured to display the left-eye and right-eye images on the display, based on the drive parameter selected by the selection section.

2. The stereoscopic display device according to claim 1, wherein given that the brightness of an image represented by the drive parameter calculated by the drive parameter calculation section diminishes with increase in the average picture-signal level, the selection section selects, from between the drive parameter corresponding to the average picture-signal level of the left-eye image and the drive parameter corresponding to the average picture-signal level of the right-eye image, the drive parameter whereby the brightness decreases.

3. The stereoscopic display device according to claim 1, wherein given that the brightness of an image represented by the drive parameter calculated by the drive parameter calculation section augments with increase in the average picture-signal level, the selection section selects one of either the drive parameter corresponding to the average picture-signal level of the left-eye image or the drive parameter corresponding to the average picture-signal level of the right-eye image, based on a mode selection signal representing a mode of use for the stereoscopic display device.

4. The stereoscopic display device according to claim 3, wherein the selection section:
selects a drive parameter for increasing the brightness from between the drive parameter corresponding to the average picture-signal level of the left eye image and the drive parameter corresponding to the average picture-signal level of the right eye image when the mode selection signal contains information representing an image enhancement mode for enhancing the images; and
selects a drive parameter for reducing the brightness from between the drive parameter corresponding to the average picture-signal level of the left eye image and the drive parameter corresponding to the average picture-signal level of the right eye image when the mode selection signal contains information representing a power-saving mode for reducing power consumption of the stereoscopic display device.

5. A stereoscopic display device for displaying left-eye and right-eye images in alternation on a display to show the images as a stereoscopic image, the stereoscopic display device comprising:
an average picture-signal level calculation section configured to calculate an average picture-signal levels of the left-eye images and the right-eye images, respectively;
an average picture-signal level selection section configured to select one of either the average picture signal level of the left-eye image or the average picture signal level of the right-eye image calculated by the average picture-signal level calculation section;
a drive parameter calculation section configured to calculate a drive parameter corresponding to the average picture-signal level selected by the average picture-signal level selection section, for showing the image stereoscopically; and
a control section configured to display the left-eye and right-eye images on the display, based on the drive parameter calculated by the drive parameter calculation section.

6. The stereoscopic display device according to claim 5, wherein given that the brightness of an image represented by the drive parameter calculated by the drive parameter calculation section diminishes with increase in the average picture-signal level, the average picture-signal level selection section selects the greater of the average picture signal level of the left-eye image and the average picture-signal level of the right-eye image.

7. The stereoscopic display device according to claim 5, wherein given that the brightness of an image represented by the drive parameter calculated by the drive parameter calculation section augments with increase in the average picture-signal level, the average picture-signal level selection section selects one of either the average picture signal level of the left-eye image or the average picture signal level of the right eye image, based on a mode selection signal representing a mode of use for the stereoscopic display device.

8. The stereoscopic display device according to claim 7, wherein the average picture signal level selection section:
selects the greater of the average picture-signal level of the left-eye image and the average picture-signal level of the right-eye image when the mode selection signal contains information representing an image enhancement mode for enhancing the images; and
selects the smaller of the average picture-signal levels of the left-eye image and the average picture-signal level of the right eye image when the mode selection signal contains information representing a power-saving mode for reducing power consumption of the stereoscopic display device.

9. The stereoscopic display device according to claim 1, wherein the average picture-signal level calculation section calculates an average picture-signal level of a shared image area common to the left-eye image and the right-eye image.

10. The stereoscopic display device according to claim 1, wherein the average picture-signal level calculation section calculates the average picture-signal level of the left-eye image from a plurality of left-eye images and the average picture-signal level of the right-eye image from a plurality of right-eye images, among a plurality of temporally continuous left-eye images and right-eye images.

11. The stereoscopic display device according to claim 1, wherein:
the display is a plasma display panel; and
the control section controls brightness of the plasma display panel by adjusting light emission of subfields for the left-eye image and the right-eye image.

12. A stereoscopic display method executed by a stereoscopic display device for displaying left-eye and right-eye images in alternation on a display to show the images as a stereoscopic image, the stereoscopic display method comprising:
an average picture-signal level calculation step of calculating average picture-signal levels of the left-eye images and the right-eye images, respectively;
a drive parameter calculation step of calculating drive parameters, corresponding to the respective average picture-signal levels calculated by the average picture signal-level calculation step, for showing the image stereoscopically;
a selection step of selecting one of either the drive parameter corresponding to the average picture-signal level of the left-eye image or the drive parameter corresponding to the average picture-signal level of the right-eye image calculated by the drive parameter calculation step; and
a control step of displaying the left-eye and right-eye images on the display, based on the drive parameters selected by the selection step.

13-22. (canceled)
